(19) United States
(12) Patent Application Publication
(10) Pub. No.: US 2025/0130190 A1
(43) Pub. Date: Apr. 24, 2025

(54) EIS-based Gas Starvation Fault Diagnosis Method for Fuel Cell Stack

(71) Applicant: Robert Bosch GmbH, Stuttgart (DE)

(72) Inventors: Yafei Chang, Shanghai (CN); Hanyang Zhang, Shanghai (CN); Kai Wang, Shanghai (CN); Liyun Fu, Shanghai (CN); Ze Chen, Shanghai (CN)

(21) Appl. No.: 18/918,828

(22) Filed: Oct. 17, 2024

(30) Foreign Application Priority Data
Oct. 23, 2023 (CN) 202311376439.X

(51) Int. Cl. G01N 27/02; H01M 8/04664; H01M 8/10

(52) U.S. Cl. CPC G01N 27/026; H01M 8/04679; H01M 2008/1095

(57) ABSTRACT

An EIS-based gas starvation fault diagnosis method for a fuel cell stack is disclosed. The method includes (S1) collecting, in real time, an impedance modulus at a first characteristic frequency of the fuel cell stack, (S2) comparing the impedance modulus to a modulus reference value, and (S3) determining whether an absolute value of a difference between the impedance modulus and the modulus reference value is greater than a first threshold, if yes, identifying that a gas starvation fault occurs to the fuel cell stack, and if no, returning to step (S1) to continuously collect the impedance modulus at the characteristic frequency of the fuel cell stack. The gas starvation fault diagnosis method is capable of quickly and reliably obtaining diagnostic results and is capable of differentiating between hydrogen starvation and air starvation through different parameters.

This application claims priority under 35 U.S.C. § 119 to patent application no. CN 2023 1137 6439.X, filed on Oct. 23, 2023 in China, the disclosure of which is incorporated herein by reference in its entirety.

The present disclosure relates to health state monitoring of a fuel cell stack, and more particularly relates to an EIS-based gas starvation fault diagnosis method for a fuel cell stack.

### BACKGROUND

It is very important to monitor a state of health (SOH) of a protic exchange membrane fuel cell stack to avoid damage or severe degradation. Gas starvation (i.e., gas shortage) is a frequent fault in the operation process of the protic exchange membrane fuel cell stack. Gas starvation comprises hydrogen starvation (also known as anodic starvation) and air starvation (also known as cathodic starvation). Among them, hydrogen starvation can lead to anodic carbon corrosion, thereby seriously damaging an anodic structure. Air starvation cannot cause fatal damage, but can cause performance reduction of the fuel cell stack, and thus a resulting hydrogenation reaction will raise security concerns. It is therefore necessary to monitor gas starvation phenomena online, i.e., in real time, to avoid damage to the structure or performance reduction.

In the prior art, online diagnostic methods are mostly limited to moisture content measurements. For example, US 2019/0131638 A1 provides an EIS-based method for diagnosing a water content in a stack. However, the method does not involve the diagnosis of gas starvation faults. In addition, an EIS-based method for diagnosing hydrogen starvation and air starvation is also provided. For example, CN 109726452 B provides an impedance spectrum-based method for on-line fault diagnosis of a protic exchange membrane fuel cell. However, the method requires to measure EIS of the fuel cell stack in real time, thereby needing a longer time. Moreover, the method fails to differentiate between a hydrogen starvation fault and an air starvation fault. Both faults cause performance reduction or fluctuations, but counter measures are completely different.

It is based on the above background that the present disclosure is designed.

### SUMMARY

To address one or more problems present in the prior art, the present disclosure provides an EIS (electrochemical impedance spectrum)-based gas starvation fault diagnosis method for a fuel cell stack, the method comprising: step S1: collecting, in real time, an impedance modulus Z1 at a first characteristic frequency f1 of the fuel cell stack; step S2: comparing the impedance modulus Z1 to a modulus reference value Zref; and step S3: determining whether an absolute value of a difference between the impedance modulus Z1 and the modulus reference value Zref is greater than a first threshold ε1, if yes, identifying that a gas starvation fault occurs to the fuel cell stack, and if no, returning to step S1 to continuously collect the impedance modulus Z1 at the characteristic frequency f1 of the fuel cell stack.

In one example, in the case that the absolute value of the difference between the impedance modulus Z1 and the modulus reference value Zref is greater than the first threshold E1, the method further comprises: step S4: collecting, in real time, an impedance phase PA at a second characteristic frequency f2 of the fuel cell stack, wherein the second characteristic frequency f2 is greater than the first characteristic frequency f1; step S5: comparing the impedance phase PA to a phase reference value PAref; and step S6: determining whether an absolute value of a difference between the impedance phase PA and the phase reference value PAref is greater than a second threshold ε2, if yes, identifying that a hydrogen starvation fault occurs to the fuel cell stack, and if no, identifying that an air starvation fault occurs to the fuel cell stack.

In one example, the method further comprises: prior to the step 1, measuring EIS of the fuel cell stack under a standard working condition, a hydrogen starvation state, and an air starvation state, respectively; obtaining, based on the measured EIS, a Bode graph of responses of the impedance modulus of the fuel cell stack along with changes in frequency; and selecting the first characteristic frequency f1 based on the Bode graph, wherein at the first characteristic frequency f1, the impedance moduli of the fuel cell stack under the hydrogen starvation state and the air starvation state are substantially equal and are higher than the impedance modulus under the standard working condition.

In one example, the modulus reference value Zref is equal to the impedance modulus of the fuel cell stack at the first characteristic frequency f1 under the standard working condition.

In one example, the first characteristic frequency f1 is in a range of 1-10 Hz.

In one example, the method further comprises: obtaining, based on the measured EIS, a Bode graph of responses of an impedance phase of the fuel cell stack along with changes in frequency; and selecting the second characteristic frequency f2 based on the Bode graph, wherein at the second characteristic frequency f2, the impedance phase of the fuel cell stack under the hydrogen starvation state is lower than the impedance phase under the standard working condition, and the impedance phase of the fuel cell stack under the air starvation state is substantially equal to the impedance phase under the standard working condition.

In one example, the phase reference value PAref is equal to the impedance phase of the fuel cell stack at the second characteristic frequency f2 under the standard working condition.

In one example, the second characteristic frequency f2 is in a range of 600-5000 Hz.

In one example, the fuel cell stack comprises at least one fuel cell, and is characterized in that the method further comprises: collecting, in real time, an impedance modulus Z1′ of one of the fuel cells at a third characteristic frequency f1′; comparing the impedance modulus Z1′ to a modulus reference value Zref′; and determining whether an absolute value of a difference between the impedance modulus Z1′ and the modulus reference value Zref is greater than a third threshold ε3, and if yes, identifying that a gas starvation fault occurs to the fuel cell.

In one example, the method further comprises: collecting, in real time, an impedance phase PA′ of the fuel cell at a fourth characteristic frequency f2′, wherein the fourth characteristic frequency f2′ is greater than the third characteristic frequency f1′; comparing the impedance phase PA′ to a phase reference value PAref′; and determining whether an absolute value of a difference between the impedance phase PA′ and the phase reference value PAref is greater than a fourth threshold ε4, if yes, identifying that a hydrogen starvation fault occurs to the fuel cell, and if no, identifying that an air starvation fault occurs to the fuel cell.

The present disclosure further provides an EIS-based gas starvation fault diagnosis method for a fuel cell, the method comprising: collecting, in real time, an impedance modulus Z1′ of the fuel cell at a third characteristic frequency f1′; comparing the impedance modulus Z1′ to a modulus reference value Zref′; and determining whether an absolute value of a difference between the impedance modulus Z1′ and the modulus reference value Zref is greater than a third threshold 83, and if yes, identifying that a gas starvation fault occurs to the fuel cell; next, collecting, in real time, an impedance phase PA′ of the fuel cell at a fourth characteristic frequency f2′, wherein the fourth characteristic frequency f2′ is greater than the third characteristic frequency f1′; comparing the impedance phase PA′ to a phase reference value PAref′; and determining whether an absolute value of a difference between the impedance phase PA′ and the phase reference value PAref′ is greater than a fourth threshold ε4, if yes, identifying that a hydrogen starvation fault occurs to the fuel cell, and if no, identifying that an air starvation fault occurs to the fuel cell.

In one example, the method further comprises: measuring EIS of the fuel cell under a standard working condition, a hydrogen starvation state, and an air starvation state, respectively; obtaining, based on the measured EIS, a Bode graph of responses of an impedance modulus of the fuel cell along with changes in frequency and a Bode graph of responses of an impedance phase of the fuel cell along with changes in frequency; and selecting a third characteristic frequency f1′ and a fourth characteristic frequency f2′ based on the obtained Bode graphs, wherein at the third characteristic frequency f1′, the impedance moduli of the fuel cell under the hydrogen starvation state and the air starvation state are substantially equal, and are higher than the impedance modulus under the standard working condition, and wherein at the fourth characteristic frequency f2′, the impedance phase of the fuel cell under the hydrogen starvation state is lower than the impedance phase under the standard working condition, and the impedance phase of the fuel cell under the air starvation state is substantially equal to the impedance phase under the standard working condition.

In one example, the third characteristic frequency f1′ is in a range of 1-10 Hz, and the fourth characteristic frequency f2′ is in a range of 600-5000 Hz.

The EIS-based gas starvation fault diagnosis method for a fuel cell stack according to the present disclosure is capable of quickly and reliably obtaining diagnostic results. Moreover, the method is capable of differentiating hydrogen starvation from air starvation by different parameters, enabling appropriate control strategies to be adopted based on the diagnostic results.

The foregoing disclosure provides a brief overview of some examples of the present disclosure to provide a basic understanding of certain aspects discussed herein. This disclosure is not intended to provide a broad overview of the present disclosure, nor is it intended to delineate the scope of the present disclosure. The only objective of the disclosure is to provide some concepts in a simplified form as an introduction to the detailed description presented below.

### BRIEF DESCRIPTION OF THE DRAWINGS

The accompanying drawings, which are incorporated in and constitute a part of the Specification, illustrate specific examples of the present disclosure, and are used to interpret the present disclosure together with the general description of the present disclosure given above and the detailed description of the examples given below.

FIG. 1 shows EIS of a typical protic exchange membrane fuel cell stack and its equivalent circuit model; FIG. 2 shows schematically a test apparatus for measuring impedance of the fuel cell stack; FIG. 3 shows EIS of the fuel cell stack measured under a standard working condition, a hydrogen starvation state, and an air starvation state;

FIG. 4 shows a Bode graph obtained based on the EIS of FIG. 3 and representing responses of an impedance modulus of the fuel cell stack along with changes in frequency, wherein the transverse coordinate represents the frequency, shown in a logarithmic form, and the longitudinal coordinate represents the impedance modulus;

FIG. 5 shows a Bode graph obtained based on the EIS of FIG. 3 and representing responses of an impedance phase of the fuel cell stack along with changes in frequency, wherein the transverse coordinate represents the frequency, shown in a logarithmic form, and the longitudinal coordinate represents the impedance phase;

FIG. 6 is a flow chart of an online process of an EIS-based gas starvation fault diagnosis method for a fuel cell stack according to one example of the present disclosure.

It will be understood that the appended accompanying drawings give only a simplified representation to some extent of various features illustrating basic principles of the present disclosure. The specific design features disclosed herein (including, for example, the specific dimensions, orientations, locations, and shapes of various illustrated components) may be determined in part by particular intended applications and using environments.

### DETAILED DESCRIPTION

The present disclosure is described below by way of specific examples. It will be understood that the specific examples are provided for the purpose of facilitating a thorough understanding of the present disclosure and are not intended to limit the present disclosure. Accordingly, the following examples are exemplary only and the scope of protection of the present disclosure is defined only by the appended claims.

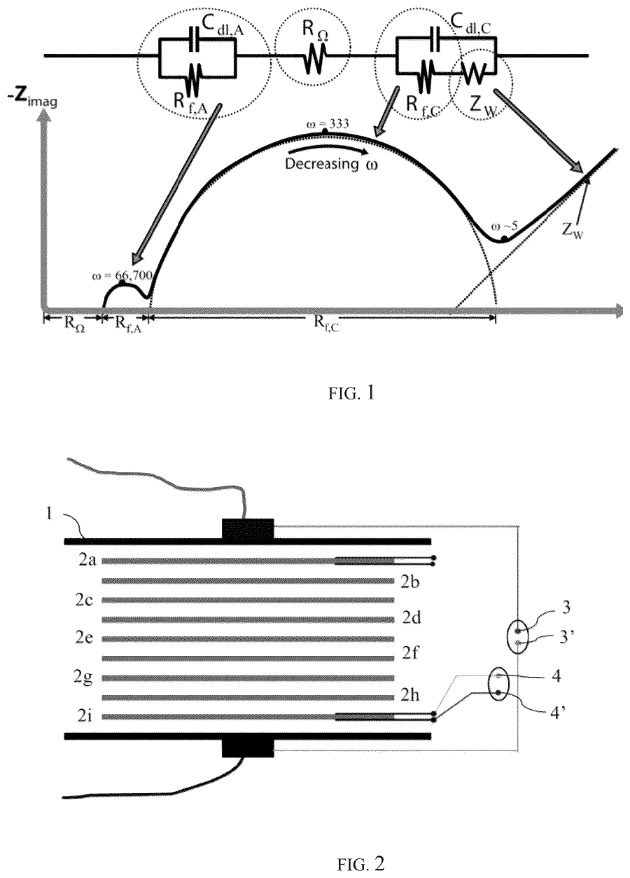

The electrochemical impedance spectrum is a characterization technique that is very widely used in electrochemistry. In the test process, a tested system is stimulated by applying a weak AC signal to a test system to obtain a corresponding feedback electrical signal. Through the EIS, kinetic information inside the tested system can be acquired without breaking the tested system. The present disclosure applies the EIS technology to the fuel cell stack, with the aim of conducting gas starvation fault diagnosis on the fuel cell stack by way of EIS. FIG. 1 shows EIS of a typical protic exchange membrane fuel cell stack and its equivalent circuit model. The EIS is measured within a frequency range of 1 Hz-10 kHz, with the measured frequency (angular velocity) gradually increasing from right to left.

As shown in FIG. 1, the EIS of the typical protic exchange membrane fuel cell stack or fuel cells thereof is in a shape of a small circle connected with a large circle, with an upward tail. Among them, the ohmic loss is caused by proton and electron transfer, which is equivalent to resistance RΩ; the anodic activation loss is caused by hydrogen reactions, which is equivalent to resistance Rf,A connected in parallel with capacitance Cdl,A; and the cathodic activation loss is caused by oxygen reactions, the mass transmission loss is caused by gas transmission, and they are together equivalent to resistance Rf,C connected in series with reactive resistance ZW and then connected in parallel with capacitance Cdl,C. As such, an equivalent circuit model of the typical protic exchange membrane fuel cell stack is shown as the upper portion of FIG. 1. Typically, the anodic activation loss is difficult to detect because it is much smaller than the cathodic viability loss.

Based on the above theories, the inventors of the present application have found that when a gas starvation fault occurs to a fuel cell stack, its impedance modulus at a lower characteristic frequency (e.g., within a range of 1-10 Hz) increases significantly as compared to the standard working condition. The above standard working condition refer to a normal operation state that a gas starvation fault does not occur to the fuel cell stack, and any other type of fault also does not occur. Furthermore, when the gas starvation fault is specifically a hydrogen starvation fault, the impedance phase of the fuel cell stack is significantly lower at a higher characteristic frequency (e.g., within a range of 600-5000 Hz) as compared to the air starvation fault. Among them, the impedance phase of the fuel cell stack at the higher characteristic frequency under the air starvation fault state is substantially the same as the impedance phase under the standard working condition.

Based on the above findings, the inventors of the present application provide an EIS-based gas starvation fault diagnosis method for a fuel cell stack. The diagnosis method comprises an offline process and an online process.

The offline process comprises: measuring EIS of the fuel cell stack under a standard working condition, a hydrogen starvation state, and an air starvation state. The measurement may be performed by way of a test apparatus shown in FIG. 2. FIG. 2 illustrates schematically a fuel cell stack 1, which comprises 9 fuel cells 2a-2i sandwiched between end plates. Those skilled in the art will appreciate that the fuel cell stack 1 may comprise any other number of fuel cells. The EIS of the fuel cell stack 1 may be measured by way of measurement points 3 and 3′ in FIG. 2. FIG. 3 shows the EIS of the fuel cell stack 1 as measured under a standard working condition, a hydrogen starvation state, and an air starvation state. As shown in FIG. 3, discrete points of the EIS of the fuel cell stack 1 measured under the standard working condition, the hydrogen starvation state, and the air starvation state are represented with “O”, “□”, and “X”, respectively, which form a substantially similar shape to the EIS of the typical protic exchange membrane fuel cell stack 1 shown in FIG. 1. As can be seen from FIG. 3, under the gas starvation fault state, the upper tail on the right side of the EIS of the fuel cell stack 1 significantly shifts rightward, and the slope increases. This indicates that the resistance of the fuel cell stack 1 under the gas starvation fault state is much greater.

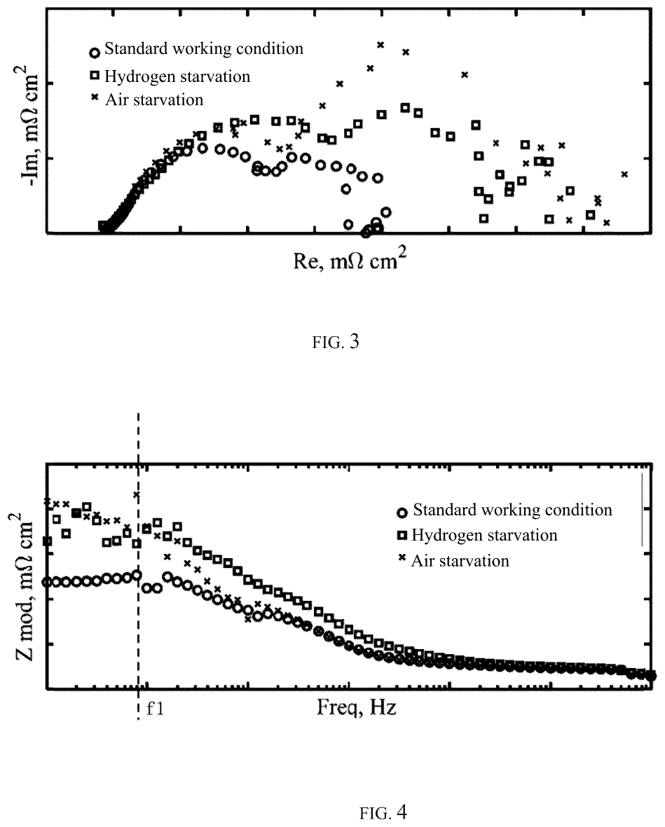

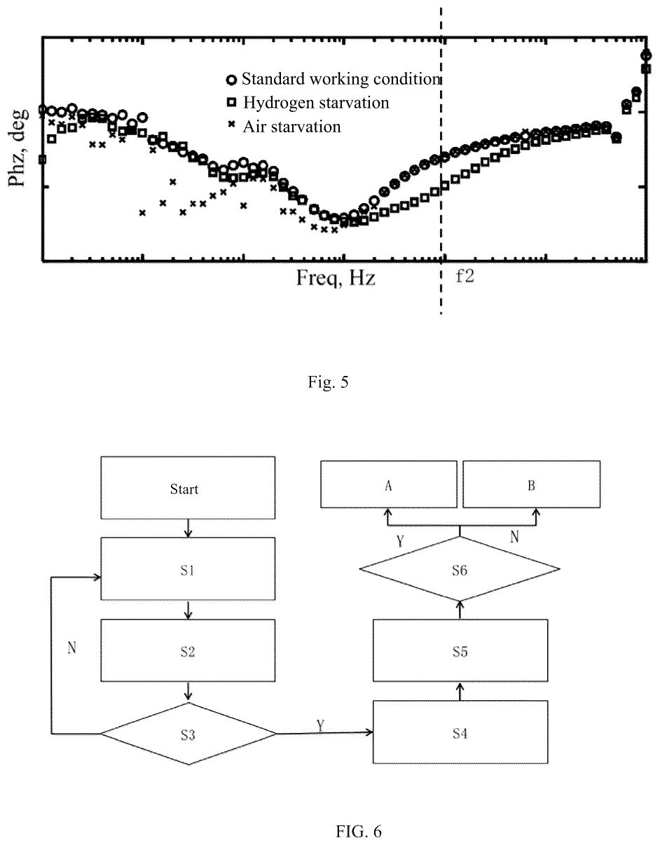

Next, the above offline process comprises: obtaining, based on the measured EIS, a Bode graph of responses of the impedance modulus of the fuel cell stack 1 along with changes in frequency (as shown in FIG. 4) and a Bode graph of responses of the impedance phase along with changes in frequency (as shown in FIG. 5). As can be seen from FIG. 4, in a low-frequency region (typically within a range of 1-10 Hz), the impedance modulus of the fuel cell stack 1 under the gas starvation fault state is significantly greater than the impedance modulus under the standard working condition. As can be seen from FIG. 5, in a high-frequency region (e.g., at a frequency of 600-5000 Hz), the impedance phase of the fuel cell stack 1 under the hydrogen starvation fault state is significantly smaller than the impedance phases under the air starvation fault state and the standard working condition. Next, the above offline process comprises: selecting a characteristic frequency f1 located in the low-frequency region and a characteristic frequency f2 located in a high-frequency region based on the obtained Bode graphs. Among them, at the characteristic frequency f1, the impedance moduli of the fuel cell stack 1 under the hydrogen starvation state and the air starvation state are substantially equal and are significantly higher than the impedance modulus under the standard working condition. Thus, the characteristic frequency f1 contributes to the diagnosis of a gas starvation fault. At the characteristic frequency f2, the impedance phase of the fuel cell stack 1 under the hydrogen starvation state is significantly lower than the impedance phase under the standard working condition, and the impedance phase of the fuel cell stack 1 under the air starvation state is substantially equal to the impedance phase under the standard working condition. Thus, the characteristic frequency f2 contributes to further differentiating the diagnosed gas starvation fault as a hydrogen starvation fault or an air starvation fault. The above terms “substantially equal” and “substantially the same” refer to the difference between the two being maintained within a certain threshold range, or the difference between the two being sufficiently small to be substantially negligible.

The online process of the gas starvation fault diagnosis method according to the present disclosure will be described in detail below. The online process comprises the steps shown in the flow chart of FIG. 6. Specifically, at step S1, the online process collects, in real time, the impedance modulus Z1 at the characteristic frequency f1 determined above of the fuel cell stack 1. At step S2, the online process compares the collected impedance modulus Z1 to a modulus reference value Zref. The modulus reference value Zref may be the impedance modulus of the fuel cell stack 1 at the characteristic frequency f1 under the standard working condition. At step S3, whether an absolute value of a difference between Z1 and Zref is greater than a first threshold E1 is determined; and if no, it is indicated that a gas starvation fault does not occur to the fuel cell stack 1, at which point the online process returns to step S1 to continuously collect the impedance modulus Z1 of the fuel cell stack 1 at the characteristic frequency f1. If it is determined that the absolute value of the difference between Z1 and Zref is greater than the first threshold of ε1, it is indicated that a gas starvation fault occurs to the fuel cell stack, at which point the online process proceeds to step S4. At step S4, the online process collects, in real time, the impedance phase PA of the fuel cell stack 1 at the characteristic frequency f2. At step S5, the online process compares the collected impedance phase PA to the phase reference value PAref. The phase reference value PAref may be the impedance phase of the fuel cell stack 1 at the characteristic frequency f2 under the standard working condition. At step S6, whether the absolute value of the difference between PA and PAref is greater than the second threshold ε2 is determined. If yes, an A fault, i.e., a hydrogen starvation fault is identified. If no, a B fault, i.e., an air starvation fault is identified.

Steps S1-S3 of the above-described online process for the gas starvation fault diagnosis method are used for diagnosing whether a gas starvation fault occurs to the fuel cell stack 1; and steps S4-S6 are used for distinguishing the diagnosed gas starvation fault as a hydrogen starvation fault or an air starvation fault.

Next, the skilled person may take appropriate counter measures according to the type of gas starvation fault diagnosed. For example, when the hydrogen starvation fault occurs, the air inlet flow of hydrogen may be increased accordingly; and when the air starvation fault occurs, the air inlet flow of air may be increased accordingly.

The EIS-based gas starvation fault diagnosis method for the fuel cell stack 1 according to the present disclosure takes the time-consuming EIS measurement process offline, whereby when online fault diagnosis is conducted, only electrical signals at two characteristic frequencies are applied to the fuel cell stack 1 and the impedance moduli and phases at the characteristic frequencies are obtained accordingly, and thus the diagnostic results can be obtained quickly and reliably.

The above-described EIS-based gas starvation fault diagnosis method for the fuel cell stack 1 uses the entire stack 1 as an electrochemical testing system, and its aim is to diagnose whether a gas starvation fault occurs throughout the stack 1. Those skilled in the art will appreciate that a gas starvation fault within the stack 1 can occur at any location therein, and a gas starvation fault may occur within any number of fuel cells. The gas starvation faults that occur within these fuel cells are concentrated on the changes in EIS of the fuel cell stack 1, so that the above-mentioned gas starvation fault diagnosis method is capable of identifying the gas starvation fault that occurs within the stack 1 only by way of a device that conducts the overall measurement on the stack 1. This is capable of simplifying a measurement device, thereby saving costs.

In some cases, it may be desirable not only to diagnose whether a gas starvation fault occurs throughout the stack 1, but also to further identify which fuel cell/fuel cells within the stack 1 has/have experienced a gas starvation fault, specifically. In this instance, the above EIS-based gas starvation fault diagnosis method for the fuel cell stack 1 may also comprise diagnosis steps performed for certain fuel cells therein.

In one preferred example according to the present disclosure, EIS of the fuel cell 2i at the lowest end under the standard working condition, the hydrogen starvation state, and the air starvation state can also be measured by way of measurement points 4 and 4′ in FIG. 2. The fuel cell 2i is prone to flooding, and therefore a gas starvation fault is prone to occurring. In addition, EIS of the fuel cell 2a at the uppermost end can also be selected to be measured, as the fuel cell 2a is farthest from the air inlet and therefore a gas starvation fault is prone to occurring. Those skilled in the art will appreciate that EIS of any other fuel cell may also be measured as desired. The measured EIS will be similar to the EIS of the entire stack 1 shown in FIG. 3. Next, a Bode graph of responses of the impedance modulus of the fuel cell 2i along with changes in frequency (similar to FIG. 4) and the Bode graph of responses of the impedance phase along with changes in frequency (similar to FIG. 5) may be obtained based on the measured EIS. Similarly, in a low-frequency region (typically within a range of 1-10 Hz), the impedance modulus of the fuel cell 2i under the gas starvation fault state is significantly greater than the impedance modulus under the standard working condition; and in a high-frequency region (e.g., at the frequency of 600-5000 Hz), the impedance phase of the fuel cell 2i under the hydrogen starvation fault state is significantly smaller than the impedance phases under the air starvation fault state and the standard working condition. Next, the characteristic frequency f1′ located in the low-frequency region and the characteristic frequency f2′ located in the high-frequency region may then be selected based on the obtained Bode graphs. Among them, at the characteristic frequency f1′, the impedance moduli of the fuel cell 2i under the hydrogen starvation state and the air starvation state are substantially equal and are significantly higher than the impedance modulus under the standard working condition. Thus, the characteristic frequency f1′ contributes to the diagnosis of the gas starvation fault of the fuel cell 2i. At the characteristic frequency f2′, the impedance phase of the fuel cell 2i under the hydrogen starvation state is significantly lower than the impedance phase under the standard working condition, and the impedance phase of the fuel cell 2i under the air starvation state is substantially equal to the impedance phase under the standard working condition. Thus, the characteristic frequency f2′ contributes to further differentiating the diagnosed gas starvation fault as a hydrogen starvation fault or an air starvation fault. The characteristic frequency f1′ of the fuel cell 2i may be proximate to the characteristic frequency f1 of the entire stack 1, or even equal to f1. Similarly, the characteristic frequency f2′ of the fuel cell 2i may be proximate to the characteristic frequency f2 of the entire stack 1, or even equal to f2.

An offline process of a gas starvation fault diagnosis method performed for the fuel cell 2i is described above, and an online process for the diagnosis method is described below, with the online process similar to the process described above with reference to FIG. 6. First, the impedance modulus Z1′ at the characteristic frequency f1′ of the fuel cell 2i is collected in real time, and the collected impedance modulus Z1′ is compared to the modulus reference value Zref. The modulus reference value Zref may be the impedance modulus of the fuel cell 2i at the characteristic frequency f1′ under the standard working condition. Next, whether the absolute value of the difference between Z1′ and Zref is greater than the third threshold ε3 is determined, and if no, the process returns to continuously collect the impedance modulus Z1′ of the fuel cell 2i at the characteristic frequency f1′. If it is determined that the absolute value of the difference between Z1′ and Zref is greater than the third threshold ε3, the impedance phase PA′ of the fuel cell 2i at the characteristic frequency f2′ is subsequently collected, and the collected impedance phase PA′ is compared to the phase reference value PAref. The phase reference value PAref may be the impedance phase of the fuel cell 2i at the characteristic frequency f2′ under the standard working condition. Next, whether the absolute value of the difference between PA′ and PAref′ is greater than the fourth threshold ε4 is determined. If yes, an A fault, i.e., a hydrogen starvation fault is identified. If no, a B fault, i.e., an air starvation fault is identified. The above third threshold ε3 may be proximate to the first threshold ε1, or even equal to the first threshold ε1. Similarly, the above fourth threshold ε4 may be proximate to the second threshold 82, or even equal to the second threshold ε2.

The fault diagnosis steps performed above for the fuel cell 2i contributes to the further diagnosis of whether a gas starvation fault within the stack 1 occurs to the fuel cell 2i. It will be understood that the above fault diagnosis steps may be performed for a plurality of fuel cells within the stack 1 to identify which fuel cell/fuel cells has/have experienced the gas starvation fault within the stack 1 specifically.

In one example according to the present disclosure, an EIS-based gas starvation fault diagnosis method for a fuel cell stack may comprise: performing fault diagnosis steps for only certain fuel cells within the stack, without performing fault diagnosis steps for the entire stack. At this point, these fuel cells are preferably fuel cells that are prone to experiencing a gas starvation fault within the stack. In such cases, the EIS-based gas starvation fault diagnosis method for a fuel cell stack can directly identify which fuel cell has experienced a gas starvation fault for more accurately taking counter measures.

The terms used herein are merely intended to describe particular examples and are not intended to limit examples of the present disclosure. As used herein, the singular forms “a”, “an”, and “the” are intended to include both singular and plural forms, while the terms “and” and “or” are each intended to include alternatives and groups unless the context is otherwise expressed. It will further be understood that the term “comprise” or “include” when used in the Specification designates the presence of features, integers, actions, steps, operations, elements or components but does not preclude the presence or addition of one or more other features, integers, actions, steps, operations, elements, components, or combinations thereof. Unless expressly stated otherwise, those steps described in the claims do not necessarily occur in the order described, but rather, one of the steps may occur in the opposite order or at the same time, so long as the corresponding functions can be achieved.

While all of the disclosures have been illustrated by the description of various examples, and although these examples have been described in considerable detail, it is not the intention of the applicant to limit the scope of the appended claims or to limit them in any way to these details. Additional advantages and modifications will be readily apparent to those skilled in the art. Thus, the present disclosure in its broader aspects is not limited to the specific details, representative apparatuses and methods, and illustrative examples shown and described. Accordingly, these details may be deviated without departing from the spirit or scope of the disclosure.

What is claimed is:

1. An EIS-based gas starvation fault diagnosis method for a fuel cell stack, comprising:
(S1) collecting, in real time, an impedance modulus at a first characteristic frequency of the fuel cell stack;
(S2) comparing the impedance modulus to a modulus reference value; and
(S3) determining whether an absolute value of a difference between the impedance modulus and the modulus reference value is greater than a first threshold, and if yes, identifying that a gas starvation fault occurs to the fuel cell stack, and if no, returning to step (S1) to continuously collect the impedance modulus at the characteristic frequency of the fuel cell stack.

2. The gas starvation fault diagnosis method according to claim 1, wherein in the case that the absolute value of the difference between the impedance modulus and the modulus reference value is greater than the first threshold, the method further comprises:
(S4) collecting, in real time, an impedance phase at a second characteristic frequency of the fuel cell stack, wherein the second characteristic frequency is greater than the first characteristic frequency;
(S5) comparing the impedance phase to a phase reference value; and
(S6) determining whether an absolute value of a difference between the impedance phase and the phase reference value is greater than a second threshold, and if yes, identifying that a hydrogen starvation fault occurs to the fuel cell stack, and if no, identifying that an air starvation fault occurs to the fuel cell stack.

3. The gas starvation fault diagnosis method according to claim 1, further comprising prior to step (S1):
measuring EIS of the fuel cell stack under a standard working condition, a hydrogen starvation state, and an air starvation state, respectively;
obtaining, based on the measured EIS, a Bode graph of responses of the impedance modulus of the fuel cell stack along with changes in frequency; and
selecting the first characteristic frequency based on the Bode graph,
wherein at the first characteristic frequency, the impedance moduli of the fuel cell stack under the hydrogen starvation state and the air starvation state are substantially equal and are higher than the impedance modulus under the standard working condition.

4. The gas starvation fault diagnosis method according to claim 3, wherein the modulus reference value is equal to the impedance modulus of the fuel cell stack at the first characteristic frequency under the standard working condition.

5. The gas starvation fault diagnosis method according to claim 1, wherein the first characteristic frequency is in a range of 1-10 Hz.

6. The gas starvation fault diagnosis method according to claim 3, further comprising:
obtaining, based on the measured EIS, a Bode graph of responses of an impedance phase of the fuel cell stack along with changes in frequency; and
selecting the second characteristic frequency based on the Bode graph,
wherein at the second characteristic frequency, the impedance phase of the fuel cell stack under the hydrogen starvation state is lower than the impedance phase under the standard working condition, and the impedance phase of the fuel cell stack under the air starvation state is substantially equal to the impedance phase under the standard working condition.

7. The gas starvation fault diagnosis method according to claim 6, wherein the phase reference value is equal to the impedance phase of the fuel cell stack at the second characteristic frequency under the standard working condition.

8. The gas starvation fault diagnosis method according to claim 2, wherein the second characteristic frequency is in a range of 600-5000 Hz.

9. The gas starvation fault diagnosis method according to claim 2, wherein the fuel cell stack comprises at least one fuel cell, and wherein the method further comprises:
collecting, in real time, an impedance modulus at a third characteristic frequency of one of the fuel cells;
comparing the impedance modulus to a modulus reference value; and
determining whether an absolute value of a difference between the impedance modulus and the modulus reference value is greater than a third threshold, and if yes, identifying that a gas starvation fault occurs to the fuel cell.

10. The gas starvation fault diagnosis method according to claim 9, further comprising:
collecting, in real time, an impedance phase of the fuel cell at a fourth characteristic frequency, wherein the fourth characteristic frequency is greater than the third characteristic frequency;
comparing the impedance phase to a phase reference value; and
determining whether an absolute value of a difference between the impedance phase and the phase reference value is greater than a fourth threshold, and if yes, identifying that a hydrogen starvation fault occurs to the fuel cell, and if no, identifying that an air starvation fault occurs to the fuel cell.

11. An EIS-based gas starvation fault diagnosis method for a fuel cell, comprising:
collecting, in real time, an impedance modulus at a third characteristic frequency of the fuel cell;
comparing the impedance modulus to a modulus reference value;
determining whether an absolute value of a difference between the impedance modulus and the modulus reference value is greater than a third threshold, and if yes, identifying that a gas starvation fault occurs to the fuel cell;
next, collecting, in real time, an impedance phase of the fuel cell at a fourth characteristic frequency, wherein the fourth characteristic frequency is greater than the third characteristic frequency;
comparing the impedance phase to a phase reference value; and
determining whether an absolute value of a difference between the impedance phase and the phase reference value is greater than a fourth threshold, and if yes, identifying that a hydrogen starvation fault occurs to the fuel cell, and if no, identifying that an air starvation fault occurs to the fuel cell.

12. The gas starvation fault diagnosis method according to claim 11, further comprising:
measuring EIS of the fuel cell under a standard working condition, a hydrogen starvation state, and an air starvation state, respectively;
obtaining, based on the measured EIS, a Bode graph of responses of the impedance modulus of the fuel cell along with changes in frequency and a Bode graph of responses of the impedance phase of the fuel cell along with changes in frequency; and
selecting a third characteristic frequency and a fourth characteristic frequency based on the obtained Bode graphs,
wherein at the third characteristic frequency, the impedance moduli of the fuel cell under the hydrogen starvation state and the air starvation state are substantially equal, and are higher than the impedance modulus under the standard working condition, and wherein at the fourth characteristic frequency, the impedance phase of the fuel cell under the hydrogen starvation state is lower than the impedance phase under the standard working condition, and the impedance phase of the fuel cell under the air starvation state is substantially equal to the impedance phase under the standard working condition.

13. The gas starvation fault diagnosis method according to claim 11, wherein the third characteristic frequency is in a range of 1-10 Hz, and the fourth characteristic frequency is in a range of 600-5000 Hz.
